(19) United States
(12) Patent Application Publication
(10) Pub. No.: US 2004/0184386 A1
(43) Pub. Date: Sep. 23, 2004

(54) Optical pickup apparatus

(75) Inventors: Yuichi Atarashi, Tokyo (JP); Kiyono Ikenaka, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA MINOLTA HOLDINGS, INC.

(21) Appl. No.: 10/799,641

(22) Filed: Mar. 15, 2004

(30) Foreign Application Priority Data
Mar. 18, 2003 (JP) JP2003-074527

(51) Int. Cl. G11B 7/00

(52) U.S. Cl. 369/121

(57) ABSTRACT

An optical pickup apparatus includes first, second and third light sources; a light converging optical system including an objective optical element, converging a light flux emitted from the first to third light sources respectively onto first to third information recording surfaces, wherein the light converging optical system introduces the light flux emitted from the first light source as an infinite parallel light flux to be incident on the objective optical element; and a chromatic aberration correcting element suppressing a variation of a chromatic aberration based on a wavelength variation in a light flux emitted from the first light source. The light converging optical system includes a spherical aberration correcting structure to correct a spherical aberration caused by at least one of a difference in thickness among the first to third protective layers and a difference in wavelength among light fluxes from the first to third light sources.

### TECHNICAL FIELD

The present invention relates to an optical pickup apparatus and an optical element used for it, and particularly, to an optical pickup apparatus by which, by using light fluxes emitted from 3 light sources whose light source wavelength is different, the recording and/or reproducing of respective information can be conducted on 3 different optical information recording media.

### BACKGROUND

Recently, a research and development of a high density optical disk system by which, by using a blue violet semiconductor laser, the recording and/or reproducing can be conducted, are rapidly advanced. As an example, in the optical disk by which the information recording/reproducing is conducted under the specification of NA 0.85, and the light surface wavelength of 405 nm, (hereinafter, such an optical disk is called a “high density DVD” in the present patent specification), on the optical disk of the diameter 12 cm whose dimension is the same as the DVD (NA 0.6, light source wavelength 650 nm, storage capacity 4.7 GB), the recording of the information of 20-30 GB can be conducted per 1 surface.

Hereupon, by only a fact that the information can be adequately recorded/reproduced to such a high density DVD, it can not be said that a value as the product of the optical pickup apparatus is enough. At present, when an actuality that the DVD or CD in which various kinds of information are recorded, is sold, is taken into account, it is not sufficient by only a fact that the information can be adequately recorded/reproduced to the high density DVD, and for example, also to the conventional DVD or CD which possessed by the user, a fact that the information can be adequately recorded/reproduced in the same manner, leads to heighten the value of the product as the exchangeable type optical pickup apparatus. From such a background, a light converging optical system used for the exchangeable type optical pickup apparatus is, also to any one of the high density DVD, conventional type DVD, or CD, it is desired that the information can be adequately recorded/reproduced. As an example of such a exchangeable type optical pickup apparatus, for example, it is written in the following patent Document 1.

Patent Document 1

Tokkai No. 2001-43559

Hereupon, for such a high density DVD, because the usable light source is limited, the wavelength used for it is almost determined, however, the specifications such as the protective substrate thickness, storage capacity, and NA, are not yet standardized. For example, for the high density DVD, when it is considered that the recording density is made to be largely increased, it is desired that, in order to, initially, increase NA of an objective lens, and lighten as much as possible the aberration deterioration caused by an accuracy error which becomes severe accompanied to it, the protective substrate (also called protective layer) thickness is decreased. Inversely, when NA of the objective lens is made the same standard as the conventional optical disk such as the DVD, the physical recording density is not largely increased, however, because the performance required as the optical system becomes comparatively loose, the necessity that the protective substrate thickness is made thin, is lowered. As a concrete specification, for the thickness of the protective substrate, the thickness of 0.1 mm, which is thinner than that of the conventional DVD, or the thickness of 0.6 mm which is the same as the conventional DVD, is proposed.

Although the light converging optical system of the optical pickup apparatus is made simple, in order to attain the recording and/or reproducing of the high density information, when NA of the objective lens at the time of use of the high density DVD is made larger (for example, 0.85) than NA when the conventional DVD is used, for example, for the objective lens, 3 optical function areas such as a common area of the high density DVD, DVD and CD, a common area of the high density DVD and DVD, and an exclusive area of the high density DVD are provided, and when the transmitting light flux is made to be flared, there is an engineering by which the aberration characteristic can be made good in some degree. However, from a fact in which there is a problem that the specification of the high density DVD is not standardized as described above, and the light source of the short wavelength used when the information is recorded and/or reproduced to the high density DVD, is severe in the allowance to the refractive index change due to the temperature change of the optical element, or the fluctuation (mode-hop)of the light source wavelength, to give the optical characteristic necessary when the information is adequately recorded/reproduced also for any one of the high density DVD, conventional type DVD, and CD, to the single objective lens, is, in any case in the theory, it can be said that there are various difficult problems in the actuality. Hereupon, the engineering by which 3 optical function areas are provided in the above-described objective lens, is only an example, and what optical function area is provided, is different depending on the standard of the optical disk.

Because, for also the optical pickup apparatus itself, there is a request for the size reduction, weight reduction, particularly, the thickness reduction, for component parts, particularly for the optical element, the very severe performance is required. Generally, when the thickness of the apparatus is reduced, a working distance (a distance between the objective optical element and the optical disk) can not be secured long. For this, when the magnification of the light converging optical system is increased, the working distance can be increased, however, because there is a possibility that the image height characteristic is deteriorated thereby, there is a problem that it is not preferable. Further, when the working distance difference among the high density DVD, conventional type DVD, and CD is increased, the burden of the actuator at the time of focusing is increased, and the power consumption is also increased.

### SUMMARY

In view of these problems, the present invention is attained, and an aspect of the present invention is to provide an optical pickup apparatus by which, even while the limit of the design work of the objective optical element and production allowance is lighten, for all of, for example, the high density DVD, conventional DVD and CD, the information can be adequately recorded and/or reproduced.

The optical pickup apparatus of the present invention is characterized in that: it has the first light source of the wavelength λ1, the second light source of the wavelength λ2 (λ1<λ2), the third light source of the wavelength λ3 (λ2<λ3), and a light converging optical system including an objective optical element, and an optical pickup apparatus by which, when the light converging optical system makes light-converge the light flux from the first light source onto the first information recording surface of the first optical information recording medium through a first protective layer whose thickness is t1, the information can be recorded or reproduced, further, when the light converging optical system makes light-converge the light flux from the second light source onto the second information recording surface of the second optical information recording medium through a second protective layer whose thickness is t2, the information can be recorded or reproduced, and further, when the light converging optical system makes light-converge the light flux from the third light source onto the third information recording surface of the third optical information recording medium through a third protective layer whose thickness is t3 (t1<t3, and t2<t3), the information can be recorded or reproduced, and when the information is reproduced or recorded for the first optical information recording medium, the infinite-parallel light flux is made incident on the objective optical element, and the optical pickup apparatus has a function by which the spherical aberration generated by at least one of the difference of the first—third protective layer thickness of the first—third optical information recording media and the wavelength difference of the first—third light sources, is corrected, and has a chromatic aberration correction element which is arranged in an optical path through which the light flux projected from the first light source passes, and by which the variation of the chromatic aberration according to the wavelength variation of the first light source is suppressed.

The optical pickup apparatus of the present invention has, when the information is recorded and/or reproduced for 3 kinds of different optical information recording media, the chromatic aberration correction element which is separately provided from the objective optical element, and by which the chromatic aberration correction due to a condition change is conducted. When the chromatic aberration correction according to the condition change is made to be conducted by the chromatic aberration correction element provided separately from the objective optical element, the limitation of the design work and the production allowance of the objective optical element can be lightened. Further, the optical pickup apparatus of the present invention has a function by which the spherical aberration due to at least one of the wavelength difference among a plurality of light sources and the difference of the protective layer thickness in a plurality of optical information recording media, is corrected. When such a function is provided, the recording/reproducing can be conducted on the light sources having the different wavelengths and the optical information recording media having the protective layer whose thickness is different. For such a spherical aberration correction function, it is also possible to make it have the objective optical element, however, it is preferable that it is made to conduct it by the spherical aberration correction element separately provided from that. When, by the chromatic aberration correction element, the chromatic aberration correction is conducted, and the spherical aberration correction is conducted by the spherical aberration correction element, it is not necessary that the diffractive structure for the aberration correction is provided in the objective optical element, and for example, the optical surface formed of only the refractive surface can be formed, and the limitation of the design work and the production allowance is soften, and viewing in the total, the lower cost optical pickup apparatus is provided. Hereupon, in the present invention, it is not limited that the chromatic aberration correction element conducts all the chromatic aberration, but, the objective optical element may also take charge of a part of the chromatic aberration correction. In the same manner, the spherical aberration correction element does not conduct all the spherical aberration correction, but, the objective optical element may also take charge of a part of the spherical aberration correction.

### BRIEF DESCRIPTION OF THE DRAWINGS

FIG. 1 is an outline sectional view of an optical pickup apparatus according to the embodiment of the present invention.

### DETAILED DESCRIPTION OF THE INVENTION

In the present invention, it is preferable that the first protective layer thickness t1 of the first optical information recording medium and the second protective layer thickness t2 of the second optical information recording medium satisfy the following relationship.

0.9·t1<t2<1.1·t1

In the case where such a relationship is satisfied, when recording/reproducing is conducted on the first and second optical information recording media, it is not necessary that the spherical aberration due to the thickness of respective protective layers is corrected, and the design work becomes easy.

Further, the chromatic aberration correction element and the spherical aberration correction element may be integrated one, or separated one, however, at least, it is preferable that the chromatic aberration correction element is arranged in the optical path through which the light flux projected from the first light source for which the chromatic aberration correction is most necessary, passes. On the one hand, the spherical aberration correction element may also be arranged in any one of a common optical path through which the light fluxes from each of light sources pass or single optical path.

Further, in the present invention, when the information is reproduced and/or recorded for the first optical information recording medium, because it becomes most severe aberration characteristically, when the infinite-parallel light flux is made incident on the objective optical element, the influence of the aberration deterioration at the time of tracking can be suppressed small.

In the optical pickup apparatus of the present invention, when the information is reproduced and/or recorded for the third optical information recording medium, it is preferable that a finite divergent light flux is made incident on the objective optical element. By such a structure, at least a part of the over spherical aberration generated due to the case where the third protective layer thickness of the third information recording medium is thicker than that of other optical information recording media can be cancelled by the under spherical aberration generated when the finite divergent light flux is made incident on the objective optical element.

In the optical pickup apparatus of the present invention, when the information is reproduced and/or recorded for the second optical information recording medium, it is preferable that the finite divergent light flux is made incident on the objective optical element. By such a structure, at least a part the over spherical aberration due to a case where the wavelength of the second light source is longer than that of the first light source, can be cancelled.

Further, in the present invention, it is preferable that, when the information is reproduced or recorded for the second information recording medium, a diverging angle of the finite divergent light flux incident on the objective optical element is smaller than the diverging angle of the finite divergent light flux incident on the objective optical element when the information is reproduced or recorded for the third information recording medium.

In the optical pickup apparatus of the present invention, it is preferable in a point in which the number of parts can be reduced, that the light converging optical system includes a collimator, and the light fluxes projected from the first light source, the second light source and the third light source pass through the same collimator and go forward to the objective optical element.

In the optical pickup apparatus of the present invention, it is preferable in a point in which the reduction to the low cost and the space saving can be intended, that the second light source and the third light source are attached to the same substrate.

In the optical pickup apparatus of the present invention, it is preferable in a point in which the reduction to the low cost and the space saving can be more intended, that the first light source, the second light source and the third light source are arranged in an equal direction from the objective optical element.

In the optical pickup apparatus of the present invention, it is preferable that the chromatic aberration correction element is at least one of a beam expander, collimator and coupling lens, and it is more preferable that it is the beam expander. As more specific structure, the structure such as the diffractive structure, phase structure, and multi-level can be given to at least one optical surface of the beam expander, collimator, and coupling lens.

In the optical pickup apparatus of the present invention, it is preferable that at least a part of the spherical aberration correction element is movable in the optical axis direction. By such a structure, corresponding to the condition such as the light source wavelength in the recording and/or reproducing of the information, magnification, substrate thickness, and temperature, by moving a part of the spherical aberration correction element, the spherical aberration correction can be freely conducted.

In the optical pickup apparatus of the present invention, it is preferable that the spherical aberration correction element is at least one of the beam expander, collimator, coupling lens, and objective optical element, and it is more preferable that it is the beam expander. As the more specific structure, the structure such as the diffractive structure, phase structure, and multi-level can be given to at least one optical surface of the beam expander, collimator, coupling lens and objective optical element.

In the optical pickup apparatus of the present invention, it is also preferable that the spherical aberration correction element is a liquid crystal element. Corresponding to the condition such as the light source wavelength in the recording and/or reproducing of the information, magnification, substrate thickness, and temperature, by moving the liquid crystal element, the spherical aberration correction can be freely conducted. As an example of a liquid crystal element, there is an element having the structure laminated in the order of an insulation substrate (for example, a glass substrate), electrode, liquid crystal molecule layer, electrode, insulation substrate (for example, a glass substrate), and in such a liquid crystal element, at least one of electrodes is divided into the ring-shaped zone pattern around the optical axis. By using a spherical aberration change signal of a light converging spot on the information recording surface generated according to the output signal of a light detection unit, when a predetermined voltage is impressed in the electrode onto the electrode divided into the ring-shaped pattern in this manner, an arrangement pattern of a liquid crystal molecule layer is changed ring-shaped zone-likely, as a result, a ring-shaped zone-like refractive index distribution around the optical axis can be given to the liquid crystal element. Because the spherical aberration is added to the wave front of the light flux transmitted through the liquid crystal element having such a ring-shaped zone-like refractive index distribution, thereby, the spherical aberration change generated by the wavelength change of the light source (semiconductor laser) accompanied to the temperature change can be corrected.

In the optical pickup apparatus of the present invention, it is preferable that the spherical aberration correction element corrects the spherical aberration generated corresponding to the temperature change of the objective optical element.

In the optical pickup apparatus of the present invention, it is preferable that the objective optical element is formed of plastics as a raw material.

In the optical pickup apparatus of the present invention, it is preferable that the objective optical element has the glass as a raw material.

In the optical pickup apparatus of the present invention, it is preferable that the apparatus has an aperture limit element by which the light flux can be stopped down corresponding to the numerical aperture necessary for the optical information recording medium. As the aperture limit element, there is a stop in which the stop diameter is changed corresponding to the wavelength, or an optical element in which a dichroic-coat is given onto the optical surface. When the aperture limit element can be used in combination with the spherical aberration correction element or chromatic aberration correction element, the number of parts can be reduced.

In the present specification, an objective optical element indicates, in a narrow meaning, an optical element (for example, lens) having the light converging action, which is arranged to be faced to a position of the most optical information recording medium side in the situation in which the optical information recording medium is loaded into the optical pickup apparatus, and indicates, in a wide meaning, an optical element which is movable at least in the optical direction by an actuator together with the optical element. Accordingly, in the present specification, a numerical aperture NA on the optical information recording medium side (image side) of the optical element indicates the numerical aperture NA of the surface positioned on the most optical information recording medium side of the optical element. Further, a necessary numerical aperture NA in the present specification is defined to indicate a numerical aperture regulated by the regulation of respective optical information recording media, or a numerical aperture of the objective optical element of the diffraction limit performance by which, to respective optical information recording media, corresponding to the wavelength of the used light source, a spot diameter necessary for the recording or reproducing of the information can be obtained.

A diffractive structure used in the present specification means a form in which, on the surface of the optical element, for example, on the surface of the lens, a relief is provided, and to which an action by which the light flux is converged or diverged by the diffraction, is given, and when there are an area in which the diffraction is generated, and an area in which the diffraction is not generated, it means the area in which the diffraction is generated. As a shape of the relief, it is well known that, for example, on the surface of the optical element, it is formed as an almost concentric circular ring-shaped zone around the optical axis, and when its section is viewed in a plane including the optical axis, each ring-shaped zone has a saw-toothed shape, and it includes such a shape.

In the present specification, as an optical information recording medium, there is particularly no limitation so far as it satisfies the structure of the present invention, however, for example, as the first optical information recording medium, a high density DVD system optical disk, as the second optical information recording medium, each kind of DVD system optical disk such as a DVD-ROM used for an exclusive use of reproducing, a DVD-Video and others, a DVD-RAM combinedly used for both of reproducing/recording, a DVD-R, a DVD-RW, is used. Further, as the third optical information recording medium, for example, an optical disk of a CD system such as a CD-R, and CD-RW is used.

### PREFERRED EMBODIMENT OF THE INVENTION

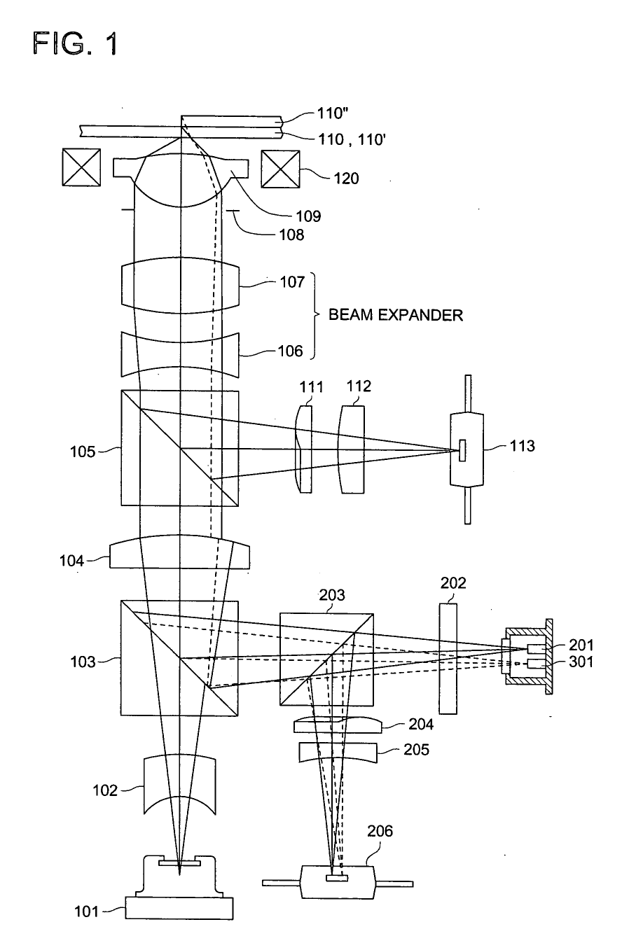

Referring to drawings, the present invention will be described in more detail below. FIG. 1 is an outline sectional view of an optical pickup apparatus by which, for all of the high density DVD (also called the first optical disk), conventional DVD (also called the second optical disk) and CD (also called the third optical disk), the information can be recorded/reproduced, according to the present embodiment.

In FIG. 1, the beam shape of the light flux projected from the first semiconductor laser 101 (the wavelength λ1=380 nm−450 nm) as the first light source, is corrected by a beam shaper 102, the light flux passes through the first beam splitter 103, and after it is formed into parallel light flux by a collimator 104, passes through the second beam splitter 105, and is incident on a beam expander having optical elements 106 and 107. Beam expander (106, 107) in which at least one of the optical elements (preferably, the optical element 106) is movable in the optical axis direction, changes (herein, enlarges) the light flux diameter of the parallel light flux, and has a function to correct the spherical aberration. Further, the diffractive structure (diffractive ring-shaped zone) is formed on the optical surface of the other optical element 107 of the beam expander, thereby, the chromatic aberration correction is conducted on the light flux projected from the first semiconductor laser 101. The diffractive structure for the chromatic aberration correction may be provided on not only the optical element 107, but also on the other optical element (collimator 104).

As described above, when the beam expander (106, 107) is provided, the chromatic aberration correction and spherical aberration correction can be conducted, and further, when the high density DVD is a type which has the information recording surface on 2 layers, by moving the optical element 106 in the optical axis direction, the selection of the information recording surface can also be conducted. The beam expander (106, 107) is arranged in the common optical path through which light fluxes from the second semiconductor laser 201, and the third semiconductor laser 301 pass.

In FIG. 1, the light flux passes through the beam expander (106, 107) passes through a stop 108, and by an objective lens 109 which is an objective optical element formed only of the refractive surface, it is light converged on the first information recording surface through the first protective layer (thickness t1=0.5−0.7 mm, preferably, 0.6 mm) of the first optical disk 110, and the light converging spot is formed here. Hereupon, the objective lens 109 may be formed of a glass as a raw material, however, because the aberration deterioration generated by the environmental change can be arbitrarily corrected by the beam expander (106, 107), and because the limitation of the required optical characteristic is lightened, a raw material of lower cost plastics can be used.

Then, because the light flux which is modulated by an information pit and reflected on the first information recording surface, passes again through the objective lens 109, stop 108, and beam expander (107, 106), and is reflected by the second beam splitter 105, the astigmatism is given by a cylindrical lens 111, and the light flux passes through a sensor lens 112, and is incident on the light receiving surface of a light detector 113, by using its output signal, a reading signal of the information recorded on the first optical disk 110 can be obtained.

Further, by detecting the shape change of the spot and the light amount change by the position change on the light detector 113, the focusing detection or track detection is conducted. Based on this detection, the second dimensional actuator 120 integrally moves the objective lens 109 in such a manner that the light flux from the first semiconductor laser 101 is focused on the fist information recording surface of the first optical disk 110.

Further, in FIG. 1, the second semiconductor laser 201 and the third semiconductor laser 301 are attached on the same substrate, and are formed into a single unit which is so called 2 laser 1 package. The light flux projected from the second semiconductor laser 201 (the wavelength λ2=600−700 nm) as the second light source, passes through a ¼ wavelength plate 202, passes through the third beam splitter 203, reflected on the first beam splitter 103, and becomes the parallel light flux while the light flux diameter is stopped down by the collimator 104, passes through the second beam splitter 105, and is incident on the beam expander (106, 107), and converted herein into the finite divergent light flux having a gentle diverging angle. As described above, the beam expander (106, 107) can conduct the spherical aberration correction. Hereupon, to the collimator 104 as an aperture limit element, a dichroic coat is given, and when a pass-through area of the light flux is limited corresponding to the wavelength, for example, for the light flux from the first semiconductor laser 101, the numerical aperture of the objective lens 109 NA=0.65 is realized, and for the light flux from the second semiconductor laser 201, the numerical aperture of the objective lens 109 NA=0.65 is realized, and for the light flux from the third semiconductor laser 301, the numerical aperture of the objective lens 109 NA=0.45 is realized. Hereupon, a combination of the numerical apertures is not limited to this.

In FIG. 1, the light flux passed through the beam expander (106, 107), passes through a stop 108 under the finite diverging condition having the gentle diverging angle, and is light converged on its second information recording surface through the second protective layer of the second optical disk 110′ (thickness t2=0.5−0.7 mm, preferably, 0.6 mm) by the objective lens 109 formed of only the refractive surface, and the light converging spot is formed here.

Then, because the light flux modulated by the information pit and reflected on the second information recording surface passes through again the objective lens 109, stop 108, beam expander (107, 106), second beam splitter 105, and collimator 104, reflected by the beam splitter 103, and successively, reflected by the third splitter 203, after that, the astigmatism is given by the cylindrical lens 204, and the light flux passes through the sensor lens 205, and is incident on the light receiving surface of the light detector 206, by using its output signal, the reading signal of the information recorded in the second optical disk 110′ is obtained.

Further, by detecting the shape change of the spot on the light detector 113, and the light amount change by the position change, the focusing detection or track detection is conducted. Based on this detection, the second dimensional actuator 120 integrally moves the objective lens 109 in such a manner that the light flux from the third semiconductor laser 301 is focused on the second information recording surface of the second optical disk 110′.

Further, in FIG. 1, the light flux projected from the third semiconductor laser 301 (the wavelength λ3=770 nm−830 nm) as the third light source, passes through a ¼ wavelength plate 202, passes through the third beam splitter 203, reflected on the first beam splitter 103, and becomes the parallel light flux while the light flux diameter is stopped down by the collimator 104, passes through the second beam splitter 105, and is incident on the beam expander (106, 107), and converted herein into the finite divergent light flux having more intensive (larger) diverging angle than the case of the light flux of the second semiconductor laser 201. In the same manner, the beam expander (106, 107) can conduct the chromatic aberration correction and the spherical aberration correction.

In FIG. 1, the light flux passed through the beam expander (106, 107), passes through the stop 108 under the finite diverging condition having the intensive diverging angle, and is light converged on its third information recording surface through the third protective layer (thickness t3=1.1−1.3 mm, preferably, 1.2 mm) of the third optical disk 110″ by the objective lens 109 formed of only the refractive surface, and the light converging spot is formed here.

Then, because the light flux modulated by the information pit and reflected on the third information recording surface passes through again the objective lens 109, stop 108, beam expander (107, 106), second beam splitter 105, and collimator 104, reflected by the beam splitter 103, and successively, reflected by the third splitter 203, after that, the astigmatism is given by the cylindrical lens 204, the light flux passes through the sensor lens 205, and is incident on the light receiving surface of the light detector 206, by using its output signal, the reading signal of the information recorded in the third optical disk 110″ is obtained.

Further, by detecting the shape change of the spot and the light amount change by the position change on the light detector 113, the focusing detection or track detection is conducted. Based on this detection, the second dimensional actuator 120 integrally moves the objective lens 109 in such a manner that the light flux from the second semiconductor laser 201 is focused on the third information recording surface of the third optical disk 110″.

In the present embodiment described above, when beam expander (106, 107) is functioned as the chromatic aberration correction element and spherical aberration correction element, in which the chromatic aberration correction function and the spherical aberration correction function are given to the beam expander, corresponding to the condition such as the light source wavelength in the recording and/or reproducing of the information to each of optical disks, magnification, substrate thickness, and temperature, the chromatic aberration correction and spherical aberration correction can be freely conducted. Further, thereby, the design work or production of the objective lens 109 can be easily conducted. Hereupon, as the spherical aberration correction element, it is not limited to the beam expander, but the collimator to which the diffractive structure is provided, and other optical elements may also be used. Further, in spite of the beam expander, or in addition to it, the liquid crystal element may also be provided.

Referring to the embodiment, the present invention is described above, however, the present invention is not to be construed by limiting to the above embodiment, but, it is of course that the modification and improvement can be adequately conducted.

According to the present invention, while the limitation of the design work and production allowance of the objective optical element, is lightened, an optical pickup apparatus by which the information can be adequately recorded and/or reproduced for all of, for example, the high density DVD, conventional DVD, or CD, is provided.

What is claimed is:

1. An optical pickup apparatus comprising:
first, second and third light sources emitting light fluxes having wavelengths of λ1, λ2 (λ1<λ2) and λ3 (λ2<λ3) respectively;
a light converging optical system including an objective optical element, converging a light flux emitted from the first light source onto a first information recording surface on a first optical information recording medium through a first protective layer with a thickness of t1 so as to conduct recording or reproducing information for the first optical information recording medium, converging a light flux emitted from the second light source on a second information recording surface on a second optical information recording medium through a second protective layer with a thickness of t2 so as to conduct recording or reproducing information for the second optical information recording medium, and converging a light flux emitted from the third light source on a third information recording surface on a third optical information recording medium through a third protective layer with a thickness of t3 (t1<t3 and t2<t3) so as to conduct recording or reproducing information for the third optical information recording medium,
wherein the light converging optical system introduces the light flux emitted from the first light source as an infinite parallel light flux to be incident on the objective optical element when information is reproduced from or recorded on the first information recording medium; and
wherein the light converging optical system includes:
a spherical aberration correcting structure to correct a spherical aberration caused by at least one of a difference in thickness among the first to third protective layers and a difference in wavelength among light fluxes from the first to third light sources; and
a chromatic aberration correcting element arranged in an optical path where a light flux emitted from the first light source passes and suppressing a variation of a chromatic aberration based on a wavelength variation in a light flux emitted from the first light source.

2. The optical pickup apparatus of claim 1, wherein the thickness of t1 and t2 satisfy a following relationship:
0.9·t1<t2<1.1·t1.

3. The optical pickup apparatus of claim 1, comprising a spherical aberration correcting element having the spherical aberration correcting structure in a common path where all of the light fluxes emitted from the first to third light sources pass.

4. The optical pickup of claim 2, comprising a spherical aberration correcting element having the spherical aberration correcting structure.

5. The optical pickup apparatus of claim 1, wherein the objective optical element has the spherical aberration correcting structure.

6. The optical pickup apparatus of claim 1, wherein the second and third light sources are attached on the same base board.

7. The optical pickup apparatus of claim 4, wherein the second and third light sources are attached on the same base board.

8. The optical pickup apparatus of claim 1, wherein the light converging optical system introduces the light flux emitted from the third light source as a finite divergent light flux to be incident on the objective optical element when information is reproduced from or recorded on the third information recording medium.

9. The optical pickup apparatus of claim 7, wherein the light converging optical system introduces the light flux emitted from the third light source as a finite divergent light flux to be incident on the objective optical element when information is reproduced from or recorded on the third information recording medium.

10. The optical pickup apparatus of claim 1, wherein the light converging optical system introduces the light flux emitted from the second light source as a finite divergent light flux to be incident on the objective optical element when information is reproduced from or recorded on the second information recording medium.

11. The optical pickup apparatus of claim 9, wherein the light converging optical system introduces the light flux emitted from the second light source as a finite divergent light flux to be incident on the objective optical element when information is reproduced from or recorded on the second information recording medium.

12. The optical pickup apparatus of claim 11 wherein the finite divergent light flux which is incident into the objective optical element in case that information is reproduced from or recorded on the second information recording medium has a smaller divergent angle than the finite divergent light flux which is incident into the objective optical element in case information is reproduced from or recorded on the third information recording medium.

13. The optical pickup apparatus of claim 1, wherein the light converging optical system comprises a collimator, and light fluxes emitted from the first to third light sources pass through the collimator toward the objective optical element.

14. The optical pickup apparatus of claim 1, wherein the first to third light sources are arranged with the same distance from the objective optical element.

15. The optical pickup apparatus of claim 1, wherein the chromatic aberration correcting element is at least one of a beam expander, a collimator and a coupling lens.

16. The optical pickup apparatus of claim 15, wherein the chromatic aberration correcting element is a beam expander.

17. The optical pickup apparatus of claim 11, wherein the chromatic aberration correcting element is at least one of a beam expander, a collimator and a coupling lens.

18. The optical pickup apparatus of claim 17, wherein the chromatic aberration correcting element is a beam expander.

19. The optical pickup apparatus of claim 3, wherein at least a part of the spherical aberration correcting element is movable along an optical axis.

20. The optical pickup apparatus of claim 3 wherein the spherical aberration correcting element is at least one of a beam expander, a collimator and a coupling lens.

21. The optical pickup apparatus of claim 18, wherein the spherical aberration correcting element is at least one of a beam expander, a collimator and a coupling lens.

22. The optical pickup apparatus of claim 20, wherein the spherical aberration correcting element is a beam expander.

23. The optical pickup apparatus of claim 21, wherein the spherical aberration correcting element is a beam expander.

24. The optical pickup apparatus of claim 3, wherein the spherical aberration correcting element is a liquid crystal element.

25. The optical pickup apparatus of claim 3, wherein the spherical aberration correcting element corrects a spherical aberration caused by temperature variation in the objective optical element.

26. The optical pickup apparatus of claim 1, wherein the objective optical element is made of a plastic material.

27. The optical pickup apparatus of claim 23, wherein the objective optical element is made of a plastic material.

28. The optical pickup apparatus of claim 26, wherein an incidence plane of a light flux emitted from the light sources in the objective optical element is a refracting surface.

29. The optical pickup apparatus of claim 27, wherein an incidence plane of a light flux emitted from the light sources in the objective optical element is a refracting surface.

30. The optical pickup apparatus of claim 1, wherein the objective optical element is made of a glass material.

31. The optical pickup apparatus of claim 1, further comprising an aperture limiting element.
